(19) United States
(12) Patent Application Publication
(10) Pub. No.: US 2025/0238995 A1
(43) Pub. Date: Jul. 24, 2025

(54) DATA GENERATION METHOD, ASSOCIATED COMPUTER PROGRAM AND COMPUTING DEVICE

(71) Applicant: BULL SAS, LES-CLAYES-SOUS-BOIS (FR)

(72) Inventors: Nicolas WINCKLER, VILLARD BONNOT (FR); Louis DEVEZE, FONTAINE (FR); Anaïs DRUART, GRENOBLE (FR); Guillaume MORIN, GRENOBLE (FR); Loïc PAULETTO, GRENOBLE (FR)

(73) Assignee: BULL SAS, LES-CLAYES-SOUS-BOIS (FR)

(21) Appl. No.: 19/021,749

(22) Filed: Jan. 15, 2025

(30) Foreign Application Priority Data
Jan. 19, 2024 (EP) 24305123.2

(51) Int. Cl. G06T 15/00; G06T 7/00; G06V 10/74

(52) U.S. Cl. CPC G06T 15/00; G06T 7/0002; G06V 10/761; G06T 2207/20081; G06T 2207/30168

(57) ABSTRACT

The invention relates to a method for generating data, wherein the method is implemented by computer. The method includes implementing a 3D engine to produce metadata relating to a reference scene generated using the 3D engine, wherein the reference scene is representative of a predetermined target situation. The method also includes providing, as input to a control model coupled to a generative model, at least part of the metadata produced by the 3D engine; calculating, using the generative model, at least one synthetic image representative of the target situation, from an output of the control model and descriptive data relating to the target situation; and storing, in a data set, at least one calculated synthetic image.

This application claims priority to European Patent Application Number 24305123.2, filed 19 Jan. 2024, the specification of which is hereby incorporated herein by reference.

### BACKGROUND OF THE INVENTION

### Field of the Invention

At least one embodiment of the invention relates to a data generation method.

At least one embodiment of the invention also relates to a computer program and a device implementing such a method.

At least one embodiment of the invention applies to the field of computer science, and more specifically to the generation of data for training artificial intelligence models.

### Description of the Related Art

In the context of supervised learning, artificial intelligence models (such as deep learning models) generally require large amounts of data to achieve satisfactory performance after training.

As a result, it is known to collect large amounts of data representative of situations that the artificial intelligence model is likely to encounter in order to provide them to said model during its training.

Nevertheless, such a method is not entirely satisfactory.

Indeed, the data to be acquired is generally difficult and costly to produce.

Additionally, in some applications, the data acquired is generally insufficient (in terms of quantity), or even unsuitable (in terms of content) for the task that the artificial intelligence model to be trained is intended to accomplish. This problem is all the more acute for applications such as security, where the aim is to predict or detect situations that are rare by nature.

For example, a visual fire and smoke detection model used at an airport will perform all the better if the model has been trained on data with fire and smoke at the same airport. However, images of airport fires are rare, since we try as much as possible to prevent such an event from occurring.

One object of at least one embodiment of the invention is to overcome at least one of the drawbacks of the prior art.

Another object of at least one embodiment of the invention is to propose a method of obtaining data that is less costly and provides more relevant results than the known methods.

### BRIEF SUMMARY OF THE INVENTION

To this end, at least one embodiment of the invention relates to a method of the aforementioned type, the method being implemented by computer and comprising the steps of:
implementing a 3D engine to produce metadata relating to a reference scene generated by means of said 3D engine, the reference scene being representative of a predetermined target situation;
providing, as input to a control model coupled to a generative model, at least part of the metadata produced by the 3D engine;
calculating, by means of the generative model, at least one synthetic image representative of the target situation, from an output of the control model and descriptive data relating to the target situation; and
storing, in a data set, at least one calculated synthetic image.

In fact, the use of a 3D engine allows total control over the position and composition of objects in the reference scene, so that a rare target situation can be modeled. This is because a 3D engine allows control over a wide variety of object parameters in the reference scene, such as geometries, animations, textures, lighting effects, camera control, physical interactions and so on.

The use of a 3D model therefore provides a high degree of flexibility for rare situations.

Additionally, since the 3D engine has exact knowledge of the position and depth of each object in the reference scene, the optical properties of the camera, etc., the metadata output by the 3D engine is accurate and faithful to the reference scene. More precisely, the metadata obtained at the output of the 3D engine does not include any errors or approximations, unlike those that would have been obtained by another automated means, such as a third-party image processing algorithm operating on the basis of an image representative of the target situation.

Such metadata includes, for example, semantic segmentation masks for objects present in the reference scene, bounding boxes, depth maps, pose data for elements (particularly articulated elements) present in the reference scene, classes or even labels.

Finally, owing to the implementation of the control model, taking as input the metadata provided by the 3D model, the operation of the generative model is constrained, so that the synthetic images calculated by the generative model are realistic and faithful to the target situation.

The result is that, owing to one or more embodiments of the invention, the synthetic images calculated are inexpensive and relevant to the target situation.

Advantageously, the method according to one or more embodiments of the invention has one or more of the following features, taken in isolation or according to any technically possible combination:
the method further comprises an evaluation step comprising determining, for each calculated synthetic image, a corresponding score, each synthetic image stored in the data set having a score belonging to a predetermined range;
for each synthetic image, the corresponding score is representative of a quality of said synthetic image and/or of a similarity of said synthetic image with at least one predetermined image;
the method further comprises associating, with each synthetic image, at least part of the metadata produced by running the 3D engine, preferably at least part of the metadata supplied as input to the control model;
the method further comprises training a computer vision model based on the data set, each synthetic image forming an input to the computer vision model, the associated metadata forming an expected output of the computer vision model for said input;
the method further comprises an adjustment step, prior to the calculation step, involving training the generative model based on predetermined additional data corresponding to the target situation, in order to modify the generative model.

According to at least one embodiment of the invention, a computer program is provided which comprises executable instructions, which, when they are executed by a computer, implement the steps of the method as defined above.

The computer program can be in any computer language, such as, for example, in machine language, in C, C++, JAVA, Python, etc.

According to at least one embodiment of the invention, a computing device for data generation is proposed, the computing device comprising a processing unit configured to:
implement a 3D engine to produce metadata relating to a reference scene generated by means of said 3D engine, the reference scene being representative of a predetermined target situation;
supply, as input to a control model coupled to a generative model, at least part of the metadata produced by the 3D engine;
use the generative model to calculate at least one synthetic image representative of the target situation, from an output of the control model and descriptive data relating to the target situation; and
store at least one calculated synthetic image in a data set.

The device according to at least one embodiment of the invention can be any type of apparatus such as a server, a computer, a tablet, a calculator, a processor, a computer chip, programmed to implement the method according to one or more embodiments of the invention, for example by running the computer program according to at least one embodiment of the invention.

### BRIEF DESCRIPTION OF THE DRAWINGS

The one or more embodiments of the invention will be better understood from reading the following description, which is given solely by way of non-limiting example and with reference to the accompanying drawings. These show:

FIG. 1 is a schematic depiction of a computing device according to one or more embodiments of the invention;

FIG. 2 is a flowchart of a data generation method according to one or more embodiments of the invention, implemented by the computing device of FIG. 1;

FIG. 3 is a first example of a reference scene modeled using a 3D engine of the computing device shown in FIG. 1, according to one or more embodiments of the invention;

FIG. 4 is an example of pose data obtained from the reference scene in FIG. 3, at the end of a production step in the method shown in FIG. 2, according to one or more embodiments of the invention;

FIG. 5 is an example of a synthetic image obtained from the pose data shown in FIG. 4, according to one or more embodiments of the invention;

FIG. 6 is a second example of a reference scene modeled using the 3D engine of the computing device shown in FIG. 1, according to one or more embodiments of the invention;

FIG. 7 is an example of a segmentation mask obtained from the reference scene of FIG. 6, at the end of the production step of the method shown in FIG. 2, according to one or more embodiments of the invention; and

FIG. 8 is an example of a synthetic image obtained from the segmentation mask of FIG. 7, according to one or more embodiments of the invention.

### DETAILED DESCRIPTION OF THE INVENTION

It is clearly understood that the one or more embodiments that will be described hereafter are by no means limiting. In particular, it is possible to imagine variants of the one or more embodiments of the invention that comprise only a selection of the features disclosed hereinafter in isolation from the other features disclosed, if this selection of features is sufficient to confer a technical benefit or to differentiate the at least one embodiment of the invention with respect to the prior art. This selection comprises at least one preferably functional feature which is free of structural details, or only has a portion of the structural details if this portion alone is sufficient to confer a technical benefit or to differentiate the one or more embodiments of the invention with respect to the prior art.

In particular, all of the described variants and embodiments can be combined with each other if there is no technical obstacle to this combination.

In the figures and in the remainder of the description, the same reference has been used for the features that are common to several figures.

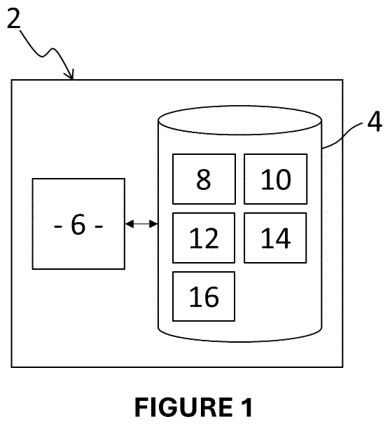

A computing device 2 according to one or more embodiments of the invention is shown by FIG. 1.

The computing device 2 is designed to generate at least one synthetic image representative of a target situation.

For example, the target situation is a rare situation for which few acquired images are available (such as an airport fire).

As shown by FIG. 1, in at least one embodiment, the computing device 2 comprises a memory 4 and a processing unit 6 connected to one another.

### Memory 4

The memory 4 is configured to store a 3D engine 8, a control model 10, a generative model 12 and a data set 14.

Preferably, the memory 4 is further configured to store a computer vision model 16 (hereinafter referred to as the “vision model”).

Conventionally, the 3D engine 8 is a software component configured to generate, during a so-called “rendering” operation, images of a reference scene modeled in the 3D engine 8. In particular, the reference scene is representative of the aforementioned target situation.

The 3D engine 8, in at least one embodiment, is further configured to produce metadata relating to the reference scene. In particular, such metadata is representative of an appearance of all or part of the modeled reference scene. For example, such metadata is representative of the visual aspect of the result of a 3D rendering of the reference scene (such a 3D rendering comprising, in particular, a projection of the scene on a predetermined virtual camera).

Such metadata includes, for example, semantic segmentation masks for objects present in the reference scene, bounding boxes, depth maps, pose data for elements (particularly articulated elements) present in the reference scene, classes of the objects present in the reference scene, or even classes.

In particular, in at least one embodiment, the 3D engine 8 is configured so that at least part of the metadata produced has a nature dependent on the vision model 16, for which learning is desired. For example, the 3D engine 8 is configured so that the metadata produced comprises segmentation masks if the vision model 16 is a segmentation model, classes if the vision model 16 is a classification model, bounding boxes if the vision model 16 is a detection model, and so on.

The control model 10 is an artificial intelligence model coupled to the generative model 12, and configured to perform a control of the generative model 12 (that is, to condition a behavior of the generative model 12) based on data received as input from said control model 10, in particular based on the metadata produced by the 3D engine 8.

The control model 10 has been previously configured to perform such a control. In particular, the control model 10 has been configured to process at least one predetermined type of input data, notably at least one of the metadata produced by the 3D engine 8.

For example, the control model 10 is a neural network previously trained for this purpose.

Schematically, the control model 10 is configured to transcribe the data applied to its input into a latent space compatible with the generative model 12, so that said data can, directly or indirectly, be processed by the generative model 12 (for example, by at least one layer of the generative model 12).

For example, the control model 10 is the ControlNet model, described by Lvmin Zhang et al. in the digital prepublication “Adding Conditional Control to Text-to-Image Diffusion Models”, referenced arXiv:2302.05543. In particular, such a model is suitable for controlling a generative “diffusion” model.

According to another example, the control model 10 is the T2I-Adapter model, described by Chong Mou et al. in the digital prepublication “T2I-Adapter: Learning Adapters to Dig out More Controllable Ability for Text-to-Image Diffusion Models”, referenced arXiv:2302.08453. Such a model is also suitable for controlling a diffusion model.

The way in which the control model cooperates with the generative model 12 will be described in more detail later.

The generative model 12 is an artificial intelligence model configured to calculate (that is, generate) at least one synthetic image from descriptive data representative of a predetermined situation, in particular the target situation.

Additionally, the generative model 12 is configured to calculate each synthetic image based on an output from the control model 10. In other words, an execution of the generative model 12 is constrained by the output of the control model 10.

The generative model 12 has been previously configured to perform such a synthetic image calculation. For example, the control model 10 is a neural network previously trained for this purpose.

In particular, the generative model 12 is a diffusion model, and more specifically a “text-to-image” model, configured to calculate each synthetic image from textual data describing the predetermined situation (in particular the aforementioned target situation).

For example, the generative model 12 is the Stable Diffusion model, described by Robin Rombach et al. in the digital prepublication “High-Resolution Image Synthesis with Latent Diffusion Models”, referenced arXiv:2112.10752.

In this case, the ControlNet model, previously mentioned as an example of a control model, has been configured by first making a copy of the encoder weights of the Stable Diffusion model, and then training said copy to take as input a condition (e.g. a segmentation mask), different from the usual inputs of the Stable Diffusion model.

The result of such training is connected to the rest of the ControlNet model by “zero convolution”, that is, a 1×1 convolution initialized to 0 (to avoid noise injection at the start of training) and which is learned during training. Additionally, the outputs of the encoder copy are connected by other zero convolutions to the Stable Diffusion model, which is completely frozen.

In this case, said condition, transformed by the control model 10 and represented in the latent space, is simply added to the input of the generative model 12, also represented in its latent space.

Similarly, in the case where the generative model 12 is Stable Diffusion, the T2I-adapter control model is configured to implement trainable feature extractors for each external condition, whose outputs are added to the outputs of the four encoder stages of the Stable Diffusion model.

The data set 14 is able to store at least part of the synthetic images calculated by the generative model 12.

Preferably, in at least one embodiment, the data set 14 is able to store each synthetic image in association with at least one corresponding metadata. Such an association will be described later.

### Processing Unit 6

The processing unit 6 is configured to calculate at least one synthetic image, by way of one or more embodiments.

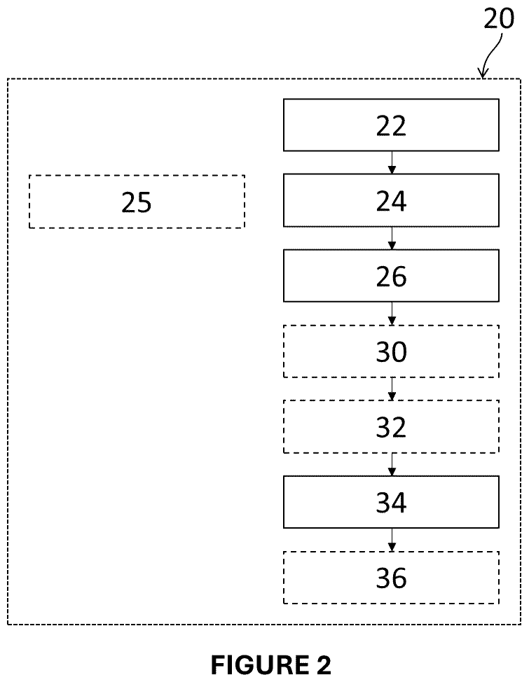

More specifically, to calculate each synthetic image, the processing unit 6 is configured to implement a data generation method 20 (FIG. 2), according to one or more embodiments of the invention.

As shown in FIG. 2, in at least one embodiment, the data generation method 20 comprises a step 22 for producing initialization data (known as the “production step”), a control step 24, a calculation step 26 and a storage step 34.

Preferably, in at least one embodiment, the data generation method 20 comprises an optional adjustment step 25, prior to the calculation step 26.

Preferably, in at least one embodiment, the data generation method 20 also comprises an optional evaluation step 30, between the calculation step 26 and the storage step 34.

Even more preferably, in at least one embodiment, the data generation method 20 also comprises an optional annotation step 32, between the calculation step 26 and the storage step 34.

Advantageously, in at least one embodiment, the data generation method 20 further comprises an optional training step 36, subsequent to the storage step 34.

### Production Step 22

The processing unit 6 is configured to run, during the production step 22, the 3D engine 8 in order to produce the metadata relating to the reference scene generated (that is, modeled) by means of said 3D engine, by way of at least one embodiment.

As previously mentioned, the reference scene is representative of the predetermined target situation.

For example, the reference scene has been previously generated by a user.

As will become clear from the following description, the purpose of step 22 is to generate initialization data, based on which the synthetic images will be calculated, according to one or more embodiments of the invention.

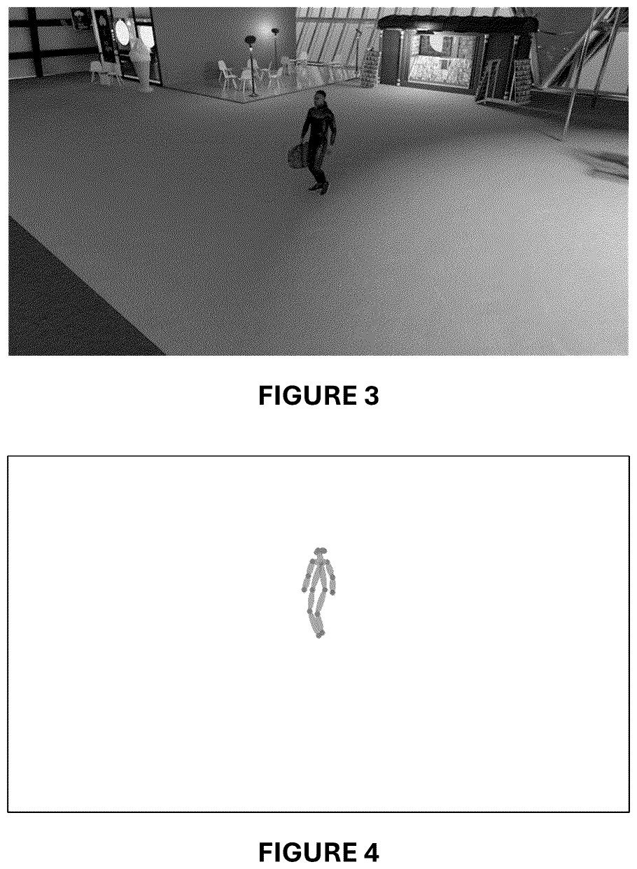

A first example of a reference scene modeled in a 3D engine is shown in FIG. 3, according to one or more embodiments of the invention. As shown in the figure, the reference scene features a human figure in the foreground, in an interior environment similar to a train station or airport concourse. The figure stands, bag in hand, arms at his sides, in a posture that suggests walking. In the background, a newsstand, an area with tables and chairs, and vending machines are visible.

FIG. 4, according to one or more embodiments of the invention, further shows a corresponding metadata generated by the 3D engine 8 based on the reference scene shown in FIG. 3. More precisely, such metadata is a two-dimensional image comprising segments arranged to form a skeleton adopting the pose of the figure in FIG. 3, in at least one embodiment.

A second example of a reference scene modeled in a 3D engine is shown in FIG. 6, according to one or more embodiments of the invention. As shown in the figure, the reference scene is representative of a suitcase with a semi-extendable handle. The suitcase is placed vertically on the floor, in the foreground, in an interior environment resembling an airport concourse. In the background, a newsstand, display stand and rows of seats are visible, along with a glass roof forming the walls of the airport.

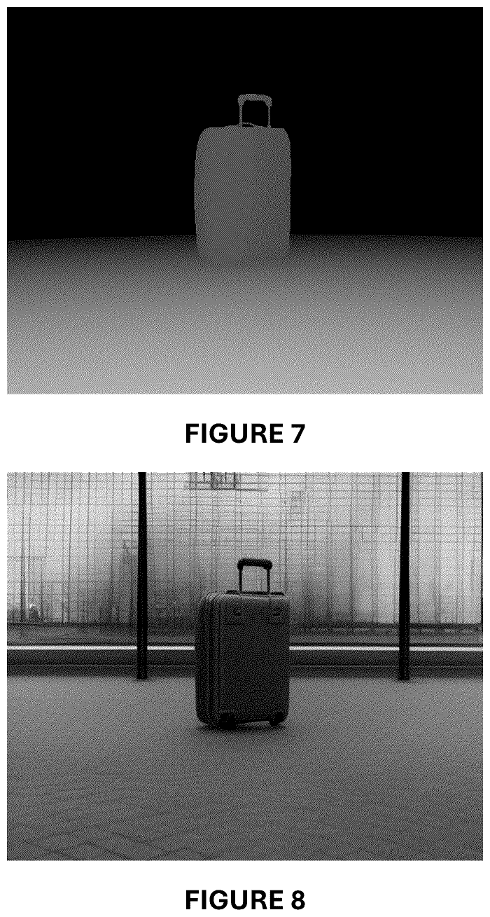

FIG. 7, according to one or more embodiments of the invention, further shows a corresponding metadata generated by the 3D engine 8 based on the reference scene shown in FIG. 6. More precisely, such metadata is a two-dimensional image comprising a segmentation mask representative of the contours of the suitcase in the image of FIG. 6, in at least one embodiment.

### Control Step 24

Additionally, in at least one embodiment, the processing unit 6 is configured to run the control model 10 during the control step 24. In particular, the processing unit 6 is configured to provide, as input to the control model 10, at least part of the metadata produced by the 3D engine 8, in order to obtain a corresponding output from the control model 10.

For example, with reference to the examples in FIGS. 3 and 4, the processing unit 6 is configured to run the control model 10 based on the two-dimensional image in FIG. 4, to produce a corresponding output, according to one or more embodiments of the invention.

### Adjustment Step 25

Preferably, in at least one embodiment, the processing unit 6 is configured to modify the generative model 12 during the adjustment step 25.

Preferably, in at least one embodiment, to carry out such a modification, the processing unit 6 is configured to train the generative model 12 based on additional data at least partly distinct from the initial training data used for initial training of the generative model 12. In particular, the additional data is selected according to a desired end application. In particular, the additional data corresponds to the target situation.

For example, in at least one embodiment, the additional data comprises images representative of objects and/or people absent from the initial training data of the generative model 12. In particular, this is preferable when the generation of images comprising specific objects is required.

In this case, the processing unit 6 is, for example, configured to implement an approach such as DreamBooth or Textual Inversion, which are conventionally known, to carry out the modification of the generative model 12.

According to another example, in at least one embodiment, the additional data is representative of desired visual features (e.g. texture, style, etc.) in the images generated by the generative model 12. In this case, said visual features are preferably captured to a controllable degree, and the generative model 12 is set so that said visual features are transcribed in the images generated by the generative model.

Such an adjustment step is advantageous in that it gives the generative model 12 the ability to generate images belonging to a visual domain (characterized, for example, by a particular environment or the brightness of a client camera) or comprising more precise, specific objects (such as unique people or objects in particular situations).

### Calculation Step 26

The processing unit 6 is further configured to run the generative model 12 during the calculation step 26, in at least one embodiment. In particular, the processing unit 6 is configured to provide, as input to the generative model 12, the output of the control model 10 and descriptive data, provided by a user and relating to the target situation, to calculate at least one synthetic image representative of said target situation.

The descriptive data are, in particular, textual data comprising a description of the target situation for which the generation of at least one synthetic image, representative of said target situation, is desired.

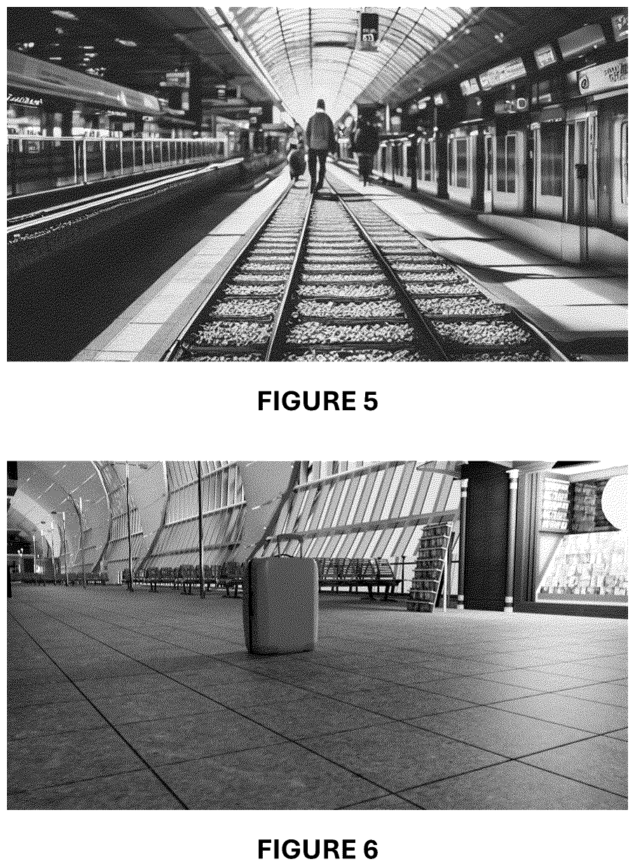

For example, in at least one embodiment, with reference to the examples in FIGS. 3 and 4, the descriptive data for the target situation is “human walking through a train station carrying a backpack”. FIG. 5 shows an example of a synthetic image obtained by supplying such inputs to the generative model 12, according to one or more embodiments. As shown in FIG. 5, the figure is in the same pose as in FIG. 4, by way of at least one embodiment.

According to another example, with reference to FIGS. 6 and 7, the descriptive data of the target situation is “realistic photo of a suitcase in a station”, according to one or more embodiments of the invention. FIG. 8 shows an example of a synthetic image obtained by supplying such inputs to the generative model 12, by way of at least one embodiment. As shown in FIG. 8, in at least one embodiment, the suitcase has the same shape as that defined by the segmentation mask in FIG. 7. In particular, the extendable handle of the suitcase in the synthetic image is deployed in the same way as the handle of the suitcase in FIG. 6, in at least one embodiment.

However, descriptive data is not limited to textual data, and may, for example, be images, provided in addition to or instead of textual data.

### Evaluation Step 30

Advantageously, in at least one embodiment, for each synthetic image calculated, the processing device 6 is further configured to determine a corresponding score during the evaluation step 30.

Preferably, in at least one embodiment, for each synthetic image calculated, the corresponding score is representative of a quality of said synthetic image.

In this case, the score determined is, for example, an FID (Fréchet Inception Distance) score, a CLER (Content-Style Loss for Exemplar Rendering) score or a CLIP (Contrastive Language-Image Pretraining) score.

Alternatively, or additionally, for each synthetic image, the corresponding score is representative of a similarity of said synthetic image with at least one predetermined image from a predetermined set of reference images.

For example, in the case of generating images representative of a fire at a given airport, the reference images are likely to be images of the airport itself.

Alternatively, or additionally, the score associated with the synthetic images is representative of a distance between a distribution of the synthetic images and a distribution of a predetermined set of reference images.

In this case, the synthetic images on the one hand, and the reference images on the other hand, are applied as input to a predetermined foundation model (e.g. a VGG, ResNet, CLIP network, etc.), previously trained based on a wide variety of semantics and images, and each layer of which encodes different information. For example, on a ResNet network, style and texture information is mainly encoded in the statistics of the first layers, while semantic information is mainly encoded in the last layers.

Then, the score determined by applying, for example, a Kullback-Leibler divergence, an MMD (Maximum Mean Discrepancy) score, or a Wasserstein distance to the outputs of predetermined layers (such as the “conv layer” or “maxpool” layers) obtained respectively for the synthetic images and for the reference images.

### Annotation Step 32

The processing unit 6 is further configured, during the annotation step 32, to associate at least part of the metadata produced by the 3D model 8 with each synthetic image, by way of at least one embodiment.

In particular, the processing unit 6 is configured to associate, with each synthetic image, at least part of the metadata supplied as input to the control model 10.

Such a feature is advantageous in that it contributes to the constitution of data that can be used in the supervised learning of an artificial intelligence model, in particular the vision model 16.

It may be noted that the order of the annotation 32 and evaluation 30 steps may be reversed during execution of the data generation method 20, according to one or more embodiments of the invention.

### Storage Stage 34

The processing unit 6, in at least one embodiment, is further configured to store at least one calculated synthetic image in the data set 14 during the storage step 34.

Advantageously, if the evaluation step 30 has been implemented, the processing device 6 is further configured to store only those synthetic images with a score belonging to a predetermined range in the data set 14. Such a feature is advantageous in that it gives the data set 14 sufficient quality for use in training an artificial intelligence model, in particular the vision model 16.

Advantageously, if the annotation step 32 has been implemented, the processing device 6 is further configured to store each synthetic image in association with the corresponding metadata in the data set 14. Such a feature is advantageous in that it allows immediate use of the data set 14 for supervised learning of an artificial intelligence model, in particular the vision model 16.

### Training Step 36

Preferably, by way of one or more embodiments, in the training step 36, the processing unit 6 is configured to train the vision model 16 based on the data set 14 constructed from the calculated synthetic images. In this case, the processing unit 6 is configured to provide the vision model 16 with each synthetic image as an input, with the associated metadata forming an expected output of the vision model 16 for said input.

Such a feature is advantageous in that it helps optimize a computer vision model for processing images representative of predetermined target situations, in particular rare target situations.

### Operation

The operation of the computing device 2 will now be described with reference to FIGS. 1 and 2, according to one or more embodiments of the invention.

In an initial step (not shown), the 3D engine 8, control model 10, the generative model 12 and the data set 14 are stored in memory 4, in at least one embodiment. Preferably, during the initial step, the vision model 16 is also stored in memory 4.

Then, in the production step 22, the processing unit 6 implements the 3D engine 8 to produce metadata relating to a reference scene modeled using said 3D engine. Such a reference scene has, for example, been previously generated by a user.

As previously mentioned, the reference scene is representative of a predetermined target situation.

Then, in the control step 24, the processing unit 6 implements the control model 10, based on at least part of the metadata produced by the 3D engine 8. This results in a corresponding output from the control model 10.

Then, during calculation 26, the processing unit 6 implements the generative model 12, based on the output of the control model 10 and descriptive data, supplied by the user and relating to the target situation. The result is at least one synthetic image representative of said target situation.

Preferably, in at least one embodiment, the processing unit 6 has previously modified the generative model 12, during the optional adjustment step 25, to give it a behavior in line with a desired end application.

Then, in the optional evaluation step 30, the processing device 6 determines a corresponding score for each calculated synthetic image.

Then, during the optional annotation step 32, the processing unit 6 associates at least part of the metadata produced by the 3D model 8 with each synthetic image.

Then, during the storage step 34, the processing unit 6 stores at least one calculated synthetic image in the data set 14.

If the evaluation step 30 has been implemented, the processing device 6 advantageously stores only those synthetic images with a score within a predetermined range in the data set 14.

Additionally, if the annotation step 32 has been implemented, the processing device 6 advantageously stores each synthetic image in association with the corresponding metadata in the data set 14.

Then, in the optional training step 36, the processing unit 6 trains the vision model 16 based on the data set 14 constructed from the calculated synthetic images. The result is a trained vision model 16 suitable, for example, for detecting the target situation.

Of course, the one or more embodiment of the invention are not limited to the examples disclosed above.

1. A computer-implemented method for generating data, the computer-implemented method comprising:
implementing a 3D engine to produce metadata relating to a reference scene generated via said 3D engine, the reference scene being representative of a predetermined target situation;
providing, as input to a control model coupled to a generative model, at least part of the metadata produced by the 3D engine;
calculating, via the generative model, at least one synthetic image representative of the predetermined target situation, from an output of the control model and descriptive data relating to the predetermined target situation; and
storing, in a data set, said at least one synthetic image that is calculated.

2. The computer-implemented method according to claim 1, further comprising an evaluation step comprising determining, for each synthetic image of said at least one synthetic image that is calculated, a corresponding score, wherein said each synthetic image is stored in the data set and having a score within a predetermined range.

3. The computer-implemented method according to claim 2, wherein, for said each synthetic image, the corresponding score is representative of one or more of a quality of said each synthetic image and a similarity of said each synthetic image with at least one predetermined image.

4. The computer-implemented method according to claim 1, further comprising associating, to each synthetic image of said at least one synthetic image, said at least part of the metadata produced by implementing the 3D engine and provided as said input to the control model.

5. The computer-implemented method according to claim 4, further comprising training a computer vision model based on the data set, said each synthetic image forming an input to the computer vision model, the metadata associated therewith forming an expected output of the computer vision model for said input.

6. The computer-implemented method according to claim 1, further comprising an adjustment step, prior to the calculating, including training the generative model based on predetermined additional data corresponding to the predetermined target situation, in order to modify the generative model.

7. A computer program comprising executable instructions which, when executed by a computer, implement a computer-implemented method for generating data. the computer-implemented method comprising
implementing a 3D engine to produce metadata relating to a reference scene generated via said 3D engine, the reference scene being representative of a predetermined target situation;
providing, as input to a control model coupled to a generative model, at least part of the metadata produced by the 3D engine;
calculating, via the generative model, at least one synthetic image representative of the predetermined target situation, from an output of the control model and descriptive data relating to the predetermined target situation; and
storing, in a data set, said at least one synthetic image that is calculated.

8. A computing device that generates data, the computing device comprising:
a processing unit that is configured to
implement a 3D engine to produce metadata relating to a reference scene generated via said 3D engine, the reference scene being representative of a predetermined target situation;
provide, as input to a control model coupled to a generative model, at least part of the metadata that is produced by the 3D engine;
calculating, via the generative model, at least one synthetic image representative of the predetermined target situation, from an output of the control model and descriptive data relating to the predetermined target situation; and
store, in a data set, said at least one synthetic image that is calculated.
